(19) United States
(12) Patent Application Publication
(10) Pub. No.: US 2022/0259462 A1
(43) Pub. Date: Aug. 18, 2022

(54) THERMO-PRINTABLE TAPE

(71) Applicant: TAJ Tech LLC, Romeo, MI (US)

(72) Inventor: Theodore A. Jacob, III, Romeo, MI (US)

(21) Appl. No.: 17/175,206

(22) Filed: Feb. 12, 2021

(51) Int. Cl. C09J 7/29; C09D 175/08; C09D 163/00; C09D 127/06; B05D 7/00

(52) U.S. Cl. CPC C09J 7/29; C09D 175/08; C09D 163/00; C09D 127/06; C09J 2427/00; C09J 2301/41; C09J 2301/162; C09J 2475/00; C09J 2463/00; B05D 7/546

(57) ABSTRACT

In an embodiment, a topcoat for a thermo-printable tape with a smooth printable surface includes a polymer blend, a crosslinker, a pigment, and a solvent. In one or more embodiments, the polymer blend includes a polyether polyurethane, a vinyl copolymer, and an epoxy polymer. In one or more embodiments, a thermo-printable tape with a smooth printable surface includes a topcoat layer, a basecoat layer, and a base substrate. In one or more embodiments, a topcoat layer is disposed on the basecoat layer. The basecoat layer is disposed on the base substrate. In one or more embodiments, the base substrate may include a first base layer, a second base layer and a support layer between the first and second base layers. One or more embodiments include a method of forming a thermo-printable tape.

### TECHNICAL FIELD

The present disclosure relates to a thermo-printable tape, and more particularly, a thermo-printable tape with a smooth printing surface.

### BACKGROUND

Heat-sealable and/or thermo-printable tapes are used for labeling and tagging industrial garments, uniforms, hunting gear, shoes, and other applications. These tapes are typically in the form of a flexible ribbon that is printable. Identifiers, barcodes, symbols and text can be printed on the tape and used for individual garments. Conventional tapes may use a scrim, tight weave, or high-count fabric such as a woven nylon or polyester fabric, which may be heat set and pre-calendared. A tight weave (e.g., 90×64) or high-count fabrics may be polyesters of various weights (e.g., 1.2 oz/yd² to 2 oz/yd²). These conventional tapes may not produce a smooth suitable surface for printing. Often, the tape's surface may adopt the contours of the woven fabric substrate. Tapes that include the contours of the weave may result in discontinuous printed content. Discontinuous printed content may make a barcode unreadable or overwhelm smaller prints because of irregularities in the surface texture. Conventional tapes may produce smooth printable surfaces by mechanical processing. For example, calendaring may be necessary to achieve a smooth printable surface on traditional tapes. Even with multiple coating layers the printing surface may follow the pattern of the woven fabric and adopt its contours. Each new coating layer may adopt the pattern of the weave and each layer may contribute to the defects in the printing surface. Calendaring may still be needed despite additives such as expanding solids and dispersible solids designed to improve the smoothness and printability of the surface. Further, the printing surface may need additional processing with solvents to remove the solids causing defects. Calendaring may be used and necessary on multiple coated layers. A smooth surface is difficult to achieve without pre-calendaring and post-calendaring the layers in many conventional tapes. Any pre- or post-processing increases cost and time of producing a product. These conventional tapes may also have weak inter-coat adhesion or bonding, resulting in the tape layers separating after multiple wash cycles. Conventional tapes, such as nylon-based tapes may also have a propensity to curl after washing, may have poor adhesion to polyester fabric and/or may be susceptible to moisture. As described herein, there is a need for a thermo-printable tape that solves one or more of these problems and/or offers an alternative to traditional tapes.

### SUMMARY

In an embodiment, a thermo-printable tape is provided. The thermo-printable tape includes a base substrate, a basecoat layer disposed on the base substrate and a topcoat layer disposed on the basecoat layer. The base substrate includes a thermoplastic polyurethane and has a first side for attaching the thermo-printable tape to a fabric substrate and a second side opposite the first side. The basecoat layer includes an at least partially crosslinked polyurethane and the topcoat layer includes a polymer network with polyurethane crosslinks formed from at least two of a polyurethane, a vinyl and an epoxy polymer. The thermo-printable tape provides a smooth printable surface on the topcoat layer with a roughness of at most 50 μin without calendaring as measured by a profilometer.

In a refinement, the base substrate further includes a first base layer including a thermoplastic polyester polyurethane forming the first side and a second base layer including a thermoplastic polyether-based polyurethane forming the second side. In a variation, the base substrate includes a support layer between the first and second base layers. In a refinement, at least one of the topcoat layer and the basecoat layer include a pigment for providing opacity. In another refinement, the polyurethane in the topcoat layer is a thermoplastic polyether-based polyurethane. In still another refinement, the vinyl has a hydroxyl content of less than 10% by weight of the vinyl and may be a vinyl copolymer. In yet another variation, the vinyl may include a vinyl chloride, a vinyl acetate, a vinyl alcohol or any combination thereof. For example, the vinyl may include a vinyl alcohol and at least one of a vinyl chloride and a vinyl acetate. In still another refinement, the polymer network is formed from a polyurethane, a vinyl and an epoxy polymer. In at least one variation, the topcoat layer has a thickness of about 2 to 130 μm, the basecoat layer has a thickness of about 2 to 130 μm, the first base layer has a thickness of about 25 to 255 μm and the second base layer has a thickness of about 25 to 255 μm.

In another variation, the thermo-printable tape provides a pull strength of at least 100 lbs/in² when adhered to the fabric substrate as measured by ASTM D1876. In a refinement, the smooth printable surface has a roughness of at most 25 μin without calendaring as measured by a profilometer. For example, in at least one embodiment, the smooth printable surface has a roughness of 10 to 25 μin without calendaring. In still another refinement, the smooth printable surface is uniform such that at least 3 different measurements of surface roughness (Rₐ) as measured by a profilometer per ASME B46.1 at 3 different locations on the smooth printable surface have an average and each of the 3 different measurements is within ±25% of the average.

In another embodiment, at least one of the topcoat layer and the basecoat layer include a pigment for providing opacity. In another variation, the topcoat and basecoat layers are at least partially crosslinked together and/or are physically entangled promoting inter-coat adhesion. In a refinement, 0.001 to 10% by weight of the of the polymer network is free reactive groups.

In one or more embodiments, a topcoat composition for a thermo-printable tape is provided. The topcoat composition is composed of about 20 to 90% by weight of a polymer blend, about 1 to 25% by weight of a crosslinker such as a polyisocyanate, about 5 to 60% of a pigment such as titanium dioxide, and a solvent. Upon drying and curing the topcoat composition forms an at least partially crosslinked coating having a smooth printable surface with a roughness of at most 50 μin without calendaring as measured by a profilometer. In a variation, the polymer blend includes a polyether-based polyurethane, a vinyl, an epoxy or a combination thereof. For example, the polymer blend my include at least two of a polyether-based thermoplastic polyurethane, a vinyl and an epoxy polymer. In a refinement, the polymer blend is about 50 to 70% by weight of the topcoat composition. In still another refinement, the polyisocyanate crosslinker is 5 to 30% free reactive groups by weight. In yet another refinement, the polymer blend includes the polyether-based polyurethane at about 10 to 60% by weight of the solids content of the polymer blend, the vinyl at about 20 to 70% by weight of the solids content of the polymer blend, and the epoxy polymer at about 3 to 20% by weight of the solids content of the polymer blend.

In at least one embodiment, a method for forming a thermo-printable tape is provided. The method includes the steps of: providing a base substrate; applying a wet basecoat layer to the base substrate; curing the wet basecoat layer to form a dry basecoat layer; applying a wet topcoat layer to the dry basecoat layer; and curing the wet topcoat layer to form a dry topcoat layer. The dry topcoat layer being bonded to the dry basecoat layer and the dry basecoat layer being bonded to the base substrate. In a refinement, the base substrate has a first side for bonding to a fabric substrate and a second side opposite the first side. In another refinement, the basecoat layer may include a first polyisocyanate crosslinker and the topcoat layer may include a second polyisocyanate crosslinker. The crosslinker and polymer blend react to form an at least partially crosslinked polymer network. In a variation, the polymer blend includes a polyether-based polyurethane, a vinyl, an epoxy polymer or a combination thereof. For example, the polymer blend includes at least two of a polyether-based polyurethane, a vinyl and an epoxy. In a refinement, the vinyl may have a hydroxyl content of less than 10% by weight. The vinyl may be a copolymer including vinyl chloride, vinyl acetate, vinyl alcohol, or a combination thereof. In a variation, providing the base substrate includes extruding a thermoplastic polyester polyurethane to form the first side and extruding a thermoplastic polyether-based polyurethane to form the second side such that the thermoplastic polyester polyurethane and polyether-based polyurethane are bonded together. In a refinement, a support layer is between the thermoplastic polyester polyurethane and the thermoplastic polyether-based polyurethane such that bonding between the polyurethanes occurs within the open structure of the support layer. In still another refinement, the wet topcoat layer is applied by spraying, extruding, gravure coating, or reverse roll coating. For example, the wet topcoat layer may be applied by reverse roll coating. The wet topcoat layer may be applied at 10 to 15 g/m². In a variation, the contact angle between the wet topcoat layer and dry basecoat layer is at most 45°.

In still another embodiment, a topcoat composition for a thermo-printable tape is provided. The topcoat layer includes about 20 to 90% by weight of a polymer blend, about 5 to 60% by weight of a pigment; and about 5 to 60% by weight of a solvent. The topcoat composition when mixed and cured with a polyisocyanate crosslinker forms a dry topcoat layer having a crosslinked polymer network. In a refinement, the polymer blend including at least two of a polyether-based polyurethane, a vinyl, and an epoxy polymer. In a refinement, the pigment is titanium dioxide.

### BRIEF DESCRIPTION OF THE DRAWINGS

FIG. 1A is a schematic illustration of a thermo-printable tape as labels on a garment such as a uniform, according to an embodiment.

FIGS. 1B-1C are schematic illustrations of the labels of FIG. 1A, according to an embodiment.

FIG. 2A is a schematic illustration of a cross-section of a thermo-printable tape, according to an embodiment.

FIG. 2B is a schematic illustration of a cross-section of a thermo-printable tape, according to another embodiment.

FIG. 3 is a flow chart of a method of making a tape, according to an embodiment.

FIG. 4 is flow chart of a method of making a tape, according to another embodiment.

### DETAILED DESCRIPTION

This disclosure incorporates U.S. application Ser. No. 16/057,391 filed Aug. 7, 2018 and published as U.S. Pub. No. 2020/0047472 on Feb. 13, 2020 by reference in its entirety.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for given purpose in connection with the invention implies the mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This invention is not limited to the specific embodiments and methods described below, as specific components and/or conditions may vary. Furthermore, the terminology used herein is used only for the purpose of describing particular embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” or “generally” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

As described herein, wet may be used to refer to a layer that contains at least one volatile component that evaporates at room temperature or during processing, such as a solvent. Likewise, dry may be used to refer to the same layer after the volatile component(s) are completely or substantially removed by, for example, evaporation. Dry may also refer to a layer that did not or does not substantially contain any volatile components, such as a hardened thermoplastic polymer layer. For example, the thickness of a coating after the volatile components have evaporated is referred to as dry film thickness.

It should be understood that the polymers described herein with reference to a specific layer is not necessarily limited to that layer. For example, a polymer described in reference to the topcoat layer may be used as a polymer in the basecoat layer and vice versa. It should also be understood that unless stated otherwise, a reference to a percentage by weight refers to the solids content or the dry layer. Unless, of course, the percentage by weight is referring to a solvent which is relative to the total weight including volatile components of the bulk material unless stated otherwise.

According to one or more embodiments, a thermo-printable tape for forming labels 100, 100′ for adhesion to textiles or fabric is provided. The thermo-printable tape includes coating layers which are cross-linked to provide strong inter-coat adhesion between the layers and improve the overall wash/wear resistance of the tape after being adhered to a textile/fabric by preventing separation of the coating layers from the texture/fabric to improve performance of the label over the life of the label. The thermo-printable tape further provides strong pull strength from the fabric/textile, as well as, a smooth printable surface capable of providing high resolution printed content and indicia on the label. The layers of the thermo-printable tape may be extruded, sprayed, gravure-coated or reverse roll coated for forming the tape. The coating layers may be crosslinked and cured such that the crosslinker bonds the polymer layers of the tape to improve the inter-coat adhesion. Details about the thermo-printable tape, coating compositions, and methods for forming the tape are provided herein.

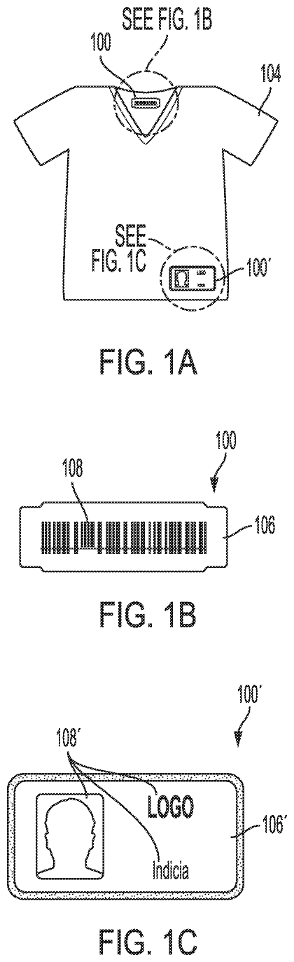

FIG. 1A illustrates labels 100 and 100′ applied to an article 104. The labels 100, 100′ are made from a thermo-printable tape that is cut to any desired size and shape and applied to article 104 to form the labels 100, 100′. Article 104 may be a fabric substrate, textile substrate, or any other suitable substrate for receiving the labels 100, 100′ and may have any suitable shape or size. For example, article 104 may be any garment, uniform, or accessory, such as, but not limited to, a shirt, pants, a bag, a vest, a jacket, a shoe, or other suitable clothing or accessory. FIGS. 1B-C illustrate the labels 100, 100′ in detail. Labels 100, 100′ include printable surface 106, 106′ for receiving printed indicia such as identifiers and/or content 108, 108′ printed on the printable surface 106, 106′. The identifiers and/or content 108, 108′ may be printed (e.g., thermally printed) onto the printable surface 106, 106′. The identifiers and/or content 108, 108′ may be text, images, barcodes, symbols, or any desired designations. For example, in FIG. 1B, the label 100 includes a barcode as the printed identifiers and/or content 108. The printable surface 106 of the label 100 is smooth and uniform such that the printed barcode is readable by a barcode scanning device. In another example, as in FIG. 1C the identifiers and/or content 108′ can be one or more images and alphanumeric text, printed on the smooth and uniform surface such that the images are high resolution and discernable (e.g., a photo ID). In certain embodiments, the thermo-printable tape may be used to form a removeable label.

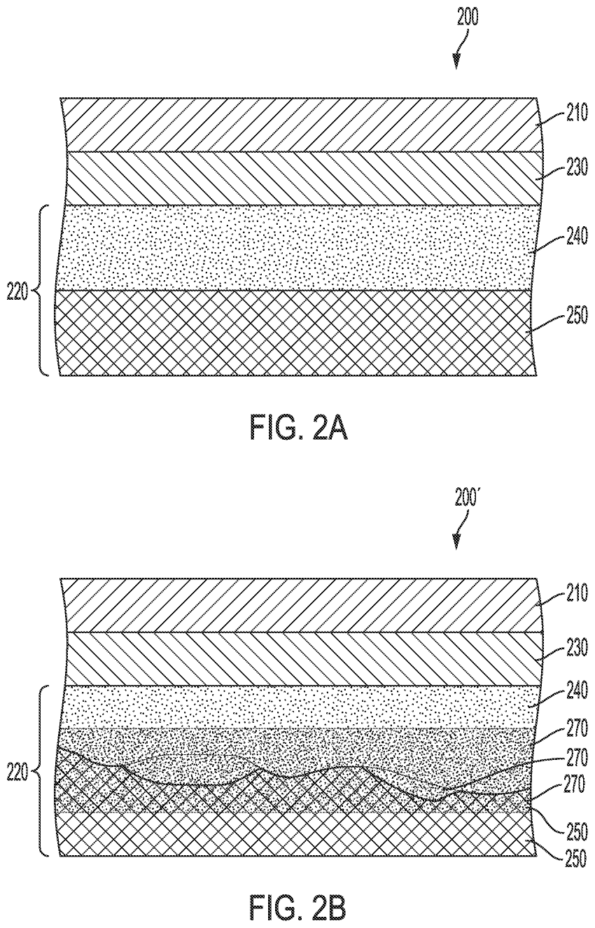

Referring to FIG. 2A, a cross-section of a thermo-printable tape 200 is shown. The thermo-printable tape 200 comprises a topcoat layer 210, a basecoat layer 230, and a base substrate 220 including a first base layer 240 and a second base layer 250. Although two base layers 240, 250 are shown in FIG. 2A, the tape 200 may include any suitable number of base layers (e.g., one or more). The topcoat layer 210 is disposed on the basecoat layer 230, which is disposed on the base substrate 220. As shown in FIG. 2A, where the base substrate 220 includes base layers 240, 250, the basecoat layer 230 may be disposed on the first base layer 240, which is disposed on the second base layer 250 or vice versa. The base substrate, in some embodiments, is about 50 to 510 μm, in other embodiments, 100 to 360 μm, and in still other embodiments, 150 to 235 μm. In a variation, the first base layer 240 may be about 25 to 255 μm, in other variations, 50 to 180 μm, and in still other variations, 75 to 105 μm. In a refinement, the second base layer 250 may be about 25 to 255 μm, in another refinement, 50 to 180 μm, and in yet another refinement, 75 to 130 μm. In one or more embodiments, the dry basecoat layer 230 may be about 2 to 130 μm, in other embodiments, 6 to 80 μm, in still other embodiments, 12 to 30 μm. In one or more embodiments, the dry topcoat layer 230 may be about 2 to 130 μm, in other embodiments, 6 to 80 μm, and in still other embodiments, 12 to 30 μm.

In certain embodiments, as shown in FIG. 2B, the thermo-printable tape 200′ may further include a support layer 270 in the base substrate 220 between the first base layer 240 and the second base layer 250. Support layer 270 provides support as a structural layer for the tape 200′. The support layer 270 also provides support when removing the label (e.g., layers of the tape) from the fabric/textile substrate. The support layer 270 may have an open structure such that the base layers 240, 250 penetrate into and/or through the support layer 270, and bond to each other to form the base substrate 220. The support layer 270 may have a void content of 10% to 50% by volume and may be a polyester scrim. The base substrate 220 provides support for a strong, flexible thermo-printable tape 200, 200′ with a smooth and uniform printable surface. Suitable features of and details about the support layer 270 are provided in U.S. application Ser. No. 16/057,391 filed Aug. 7, 2018, incorporated by reference in its entirety herein. In one or more embodiments, a support layer 270 may provide improved or increased strength.

In one or more embodiments, the combination of layers and chemical compositions described herein contribute to forming a thermo-printable tape having a smooth printable surface. For example, a smooth surface for printing barcodes may be smooth enough to provide a clear, and continuous print that is readable. A barcode, for example, must be free from broken or discontinuous print, associated with roughness, to be readable. A dotted pattern may be used to print and should appear continuous to be readable, as shown in FIGS. 1B-C. Discontinuities in the surface can cause the pattern to appear broken, and thus unreadable in the embodiment of barcodes. Smoother surfaces allow more detailed printing to be performed. Conventional tapes may have peaks and valleys in the surface which may cause roughness or discontinuities in the printing. Conventional tapes may require calendaring to provide a smooth surface, but calendaring does not always make the surface printable. In one or more embodiments, the printing surface is sufficiently smooth without the need for additional surface treatments, for example, to print a readable barcode or pattern of dots that appears continuous. In one or more embodiments, the smoothness of the surface of the tape 200 may be indicated using a measure of surface roughness (ASME B46.1) by a profilometer (or Sheffield Instrument). As the printable surface of the tape 200, 200′ is smoother than conventional tapes, the surface roughness of the tape 200, 200′ is lower than that of conventional tapes. In one or more embodiments, the surface roughness (Rₐ) is at most 50 μin, in other embodiments, at most 40 μin, and in still other embodiments, at most 25 μin. In a variation, the roughness may be about 10 to 50 μin, in another variation, 10 to 40 μin, in still another variation, 10 to 25 μin, and in still further variations, 10 to 15 μin. In one or more embodiments, the smoothness or roughness of the surface may also be measured by ISO 8791/4, an air leakage method, using a 58-06 Parker Print-Surf (PPS) from Testing Machines, Inc. located in New Castle, Del. In one or more embodiments, the roughness as measured using the PPS is at most 55 μin, in other embodiments, at most 30 μin, in still other embodiments, at most 20 μin, and in yet another embodiment, at most 15 μin. In a refinement, the roughness may be about 10 to 50 μin, in another refinement, 10 to 40 μin, in yet another refinement, 10 to 25 μin, and in still another refinement, 10 to 15 μin.

Referring again to FIGS. 2A-B, the topcoat layer 210 and the basecoat layer 230 include a polymer or polymer blend and a crosslinker. The topcoat layer 210 and basecoat layer 230 may optionally include one or more additives, such as, but not limited to pigments, fillers, dispersing agents, wetting agents, thickening agents, catalysts, and matting agents such as amorphous silicon dioxide or Syloid® 222 supplied by GRACE Davison at 7500 Grace Drive, Columbia, Md. 21044, which may provide opacity and/or better printability. Additives may be present in an amount of 0.005 to 5% by weight of the layer in some embodiments, 0.01 to 2.5% in other embodiments, and 0.1 to 1.5% in still other embodiments. In another example, a dibutyltin catalyst may be an additive and is included at 0.005 to 5% by weight of the layer, in other embodiments, 0.01 to 1%, and in still other embodiments 0.01 to 0.05%. Dibutyltin may be relevant for the crosslinking reaction between a polyol and isocyanate. The catalyst may increase the crosslink density, reduce the reaction temperature, and/or reduce the cure time. The topcoat layer 210 and the basecoat layer 230 may be chemically similar such that they cooperate to contribute to a smooth printable surface with good wash resistance.

The topcoat layer 210 (and/or basecoat layer 230) are comprised of a polymer or polymer blend having functional groups capable of reacting with a crosslinker such that the functional groups on the polymer may react with the crosslinker to form a crosslinked polymer network. It should be understood that the polymer network forming a layer may be described by its chemical composition or by describing the chemical composition of various components that are mixed and/or reacted. For example, a polymer with hydroxyl groups and a polyisocyanate crosslinker may form polyurethane crosslinks or a crosslinked polyurethane. As such, the topcoat layer 210 and the basecoat layer 230 may be linked via the crosslinker (i.e., the layers are crosslinked together). The topcoat layer 210 and basecoat layer may also be individually crosslinked and need not necessarily be crosslinked with one another. In still other embodiment, the layers may be physically bound by entanglement of polymer chains. Covalent links or physical entanglement may contribute to superior inter-coat adhesion and/or pull strength. The crosslinker may be, but is not limited to, polyisocyanates, polyamines, a melamines or combinations thereof. In some embodiments, a polyisocyanate crosslinker may be preferable, especially when crosslinking with a polyol for its resistance to discoloration such as yellowing. When referencing the crosslinker, it should be understood that the crosslinker will react with available reactive groups to crosslink a polymer and form a bonded/crosslinked polymer network. Crosslinking may provide superior wash resistance, resistance to discoloration, resistance to staining, resistance to water sublimation and/or longevity for the thermo-printable tape by enhancing strength and inter-coat adhesion. Good wash resistance may indicate that tape 200, 200′ survives multiple wash cycles with no visible indication of degradation. For example, a visible indication of degradation may include separation of layers, poor adhesion, discoloration, and/or curling. For example, in some variations, tape 200, 200′ (or label 100, 100′) may survive the wash formulas as prescribed by Table 1 and Table 2 without any visible indication of degradation (e.g., peeling or separation of edges of the label from the fabric).

TABLE 1

| Operation | Time | | Water Level | Temp. | Supplies | Volume | pH |
|---|---|---|---|---|---|---|---|
| Break | 10 | min. | Low | 160° F. | Det./Alkali | 0.5-1.0 oz | 10.5-11.0 |
| Suds | 10 | min. | Low | 160° F. | Detergent | 0.5-1.0 oz | 10.5-11.0 |
| Rinse | 2 | min. | High | 145° F. | Bleach | 0.5-1.0 oz | 10.2 (Target) |
| Rinse | 2 | min. | High | 130° F. | N/A | N/A | 9.5 |
| Finish | 3 | min. | Low | 115° F. | N/A | N/A | 8.0 |
| Rinse | 2 | min. | High | 110° F. | Anti-Chlor | 0.5-1.0 oz | 7.5 |
| Sour/Softener | 5 | min. | Low | 100° F. | N/A | N/A | 7.0 |
| Extract | 2 | min. | N/A | N/A | Sour/Softener | 0.5-1.0 oz | 4.0-5.0 |

TABLE 2

| Operation | Time | | Water Level | Temp. | Supplies | Volume | pH |
|---|---|---|---|---|---|---|---|
| Break | 3 | min. | Low | 160° F. | Det./Alkali | 0.5-1.0 oz | 10.5-11.0 |
| Suds | 10 | min. | Low | 160° F. | Detergent | 0.5-1.0 oz | 10.5-11.0 |
| Bleach | 8 | min. | Low | 150° F. | Bleach | 0.5-1.0 oz | 10.2 (Target) |
| Rinse | 2 | min. | High | 135° F. | N/A | N/A | 9.5 |
| Rinse | 2 | min. | High | 120° F. | N/A | N/A | 8.0 |
| Finish | 3 | min. | Low | 115° F. | Anti-Chlor | 0.5-1.0 oz | 7.5 |
| Rinse | 2 | min. | High | 115° F. | N/A | N/A | 7.0 |
| Finish | 5 | min. | Low | 100° F. | Sour/Softener | 0.5-1.0 oz | 4.0-5.0 |
| Extract | 2 | min. | N/A | N/A | N/A | N/A | N/A |

In one or more embodiments, the tape 200, 200′ may be evaluated on a pass/fail basis after a predetermined number of cycles as conducted per Standard Textile Co. (STC), Inc. Laboratory wash formulas as shown in Table 1 and Table 2. Drying, sterilization, and/or cool-down may be performed after the cycle. For example, drying for 20 minutes at 160° F. and five-minute cool down at room temperature (e.g., 25° F.) may follow the predetermined number of cycles. In another example, sterilization at 273° F. for 4 minutes may also be used between the drying and cool down. For example, the cycle formula per Table 1 may be used to administer 50 cycles followed by drying, sterilization and a cooled down before evaluation for pass or fail. The tape 200, 200′ may be evaluated for pass or fail after 10 cycles, 25 cycles or 50 cycles. Failure may be considered 100% separation between any two layers or from the substrate, in a refinement 25% separation, in still another refinement, 5% separation, in yet another refinement, any separation. In more or more embodiments, the tape 200, 200′, as described herein, passes after 50 cycles of either wash formula of Table 1 or Table 2 with no separation with drying, sterilization and/or a cool down.

A crosslinked topcoat layer 210 and/or basecoat layer 230 provides superior strength, resistance to discoloration, and resistance to staining. However, too much crosslinker may result in stiffness, shrinkage, and/or curling of the thermo-printable tape. The bonded/crosslinked polymer network, forming the topcoat layer 210, may have limited reactive groups remaining after crosslinking, such that, in some embodiments 0.001 to 10% by weight of the polymer blend may be free reactive groups after crosslinking; in other embodiments 0.005 to 3% of the reactive groups are still available; and in yet other embodiments 0.01 to 1%. Explained another way, the bonded polymer network in certain embodiments, may have 90 to 99.999% of the reactive groups crosslinked; in other embodiments, 97 to 99.995% of the reactive groups are crosslinked; and in yet other embodiments, 99 to 99.99% of the reactive groups are crosslinked. The free reactive groups may be determined 24 hours at 25° C. after mixing and curing the polymer blend and crosslinker. Still further, the topcoat layer 210 and basecoat layer 230 may be crosslinked together forming a polymer network that includes the topcoat layer 210 and the basecoat layer 230 with superior inter-coat adhesion. For example, in one or more embodiments, good inter-coat adhesion may indicate that the separate layers may not be physically pulled apart.

Various components will now be discussed with reference to the topcoat layer 210, the components discussed hereinafter may also be suitable in the basecoat layer 230. The polymer or polymer blend of topcoat layer 210 may include a thermoplastic polymer, such as, but not limited to, a polyether-based polyurethane (i.e., a thermoplastic polyether-based polyurethane). A polyether-based polymer, or more specifically a polyether-based polyurethane, may provide beneficial rheological and/or flow properties for providing smoothness.

In a refinement, the topcoat layer 210 may further be crosslinked (e.g., a polyol polymer and a polyisocyanate crosslinker). In some variations, the topcoat layer 210 may include a plurality of polymers including but not limited to polyurethanes, polyethers, polyesters, vinyls, epoxy polymers, and combinations thereof forming a polymer blend. Furthermore, the polymer or polymer blend may be any suitable polymer type, such as, but not limited to a homopolymer, a copolymer, a branched polymer, a crosslinked polymer, an aliphatic polymer, an aromatic polymer, a thermoplastic polymer, or combinations thereof. In some embodiments, an aliphatic polymer and/or polyurethane may be used to avoid discoloration such as yellowing. The topcoat layer 210 may include a polyether-based polyurethane with a high elongation of 100-1200%, which provides a more flexible and flat coating for the thermo-printable tape. The elongation, as determined by ASTM D412, may be greater than 100% in certain embodiments, greater than 300% in other embodiments, greater than 500% in still other embodiments, and even greater than 900% in still further embodiments. Furthermore, topcoat layer 210 may have a tensile strength greater than 500 psi in some embodiments, and greater than 800 psi in other embodiments. For example, topcoat layer 210 may include Pearlbond™ 360 EXP available from Lubrizol located in Brecksville, Ohio.

In certain embodiments, the polymer blend used to form the topcoat layer 210 may include a vinyl polymer for improving flexibility and performance of the topcoat layer 210. The vinyl may be but is not limited to polyvinyl chloride (PVC); polyvinyl acetate; polyvinyl alcohol, or combinations thereof. For example, the vinyl may be a vinyl copolymer of vinyl chloride, vinyl acetate, and vinyl alcohol. In a refinement, the vinyl copolymer may include a vinyl alcohol and at least one of a vinyl chloride and a vinyl acetate. In a variation, the vinyl copolymer may include a vinyl chloride at 78 to 98% by weight of the copolymer, a vinyl acetate at 1 to 16% by weight, and a vinyl alcohol at 1 to 16% by weight of the copolymer. The vinyl may have, in certain embodiments, a molecular weight of 2,000 to 65,000 grams per mol, in other embodiments, 10,000 to 30,000 grams per mol, and in yet other embodiments, 15,000 to 25,000 grams per mol. The vinyl may also include cross-linkable functional groups, such as but not limited to hydroxyl groups that may react with a polyisocyanate crosslinker. In certain embodiments, the vinyl may have a hydroxyl content of less than 10% by weight, in other embodiments, less than 5% by weight, and in yet other embodiments, less than 3% by weight. The vinyl may have an equivalent weight, in certain embodiments, of 690 to 790 grams per equivalent for the hydroxyl functionality, in other embodiments 715 to 765 grams, and in yet other embodiments, 725 to 755 grams. A hydroxyl content and/or equivalent weight within this range may provide a topcoat layer 210 with a crosslinking density providing superior performance and longevity. For example, a suitable vinyl for the topcoat layer 210 may be the vinyl resin solution, VAGH, from Union Carbide Corporation located in Danbury Conn.

In further embodiments, the polymer blend of topcoat layer 210 includes an epoxy polymer for chemical or stain resistance. The epoxy polymer may be difunctional, or in other embodiments, have a functionality of greater than 2. The epoxy polymer may be epichlorohydrin based, and may have an equivalent weight of, in certain embodiments, 135 to 242 grams per epoxide, in other embodiments 160 to 215 grams per epoxide, and in yet other embodiments, 185 to 192 grams per epoxide. A suitable epoxy polymer for inclusion in the topcoat layer 210 is EPON™ Resin 828 from Hexion located in Columbus, Ohio.

Thus, in one or more embodiments, the topcoat layer 210 may include a polyether-based polyurethane, a vinyl copolymer, and an epoxy polymer, which may be thermoplastic and/or crosslinked or partially crosslinked (i.e., some crosslinked polymers and some that are not). In a refinement, the topcoat layer 210 may include at least two of a polyurethane, a vinyl copolymer and an epoxy polymer. A polymer network may be formed by mixing the polyether-based polyurethane, vinyl copolymer, and epoxy polymer with a crosslinker. In one or more embodiments, a topcoat layer 210 may be formed by adding a crosslinker at 0.1 to 30% by weight of the total dry topcoat layer 210, in other embodiments at 1 to 25%, in yet other embodiments at 3 to 20%, in still other embodiments at 10 to 20%, in still more embodiments, at 1 to 5%. The dry weight or solids content (i.e., non-volatile content) may be determined by placing 0.3 gram±0.1 g spread evenly in an aluminum dish with a diameter of 11 mm for 1 hour at 110±5° C. as determined by ASTM D2369. The dry basecoat layer 230, in some embodiments, may include a crosslinker at 0.5 to 40% by weight of the total basecoat layer, in other embodiments 10 to 30%, and in still other embodiments 15 to 25%. It should be understood that the quantity of crosslinker is described as it is added, relative to the other non-volatile components, and that most of the crosslinker will ultimately react with the polymer or polymer blend to from crosslinks in the polymer network that forms the topcoat or basecoat layer.

In one or more embodiments, the crosslinker may have about 5 to 30% free reactive groups by weight of the crosslinker (before being mixed with the polymer or polymer blend), in other embodiments, about 10 to 20%, and in still other embodiments, about 14 to 16%. For example, the crosslinker may have 14 to 16% free isocyanate groups (NCO) by weight of the total crosslinker, which are free to react with free reactive groups on the polymer or polymer blend such as hydroxyl groups. In a refinement, the crosslinker may have an equivalent weight of 140 to 840 grams per isocyanate, in other refinements, 210 to 420 grams, and in yet other refinements, 265 to 300 grams. Alternatively, the equivalent weight, in some embodiments, may be 50 to 100 grams per isocyanate, in other embodiments, 65 to 95 grams, and in yet other embodiments, 80 to 90 grams. Suitable crosslinkers include Permuthane® EX-XR-96-901 available from Stahl located in the Netherlands and Natron™ i-300x from Boston Industrial Solutions in Worburn, Mass.

The solids content of the polymer or polymer blend to crosslinker, added together to form the topcoat layer 210, may be a ratio from, in some embodiments, 1:1 to 20:1 by weight, in other embodiments, 10:1 to 20:1, in still other embodiments, 2:1 to 7:1, and in yet other embodiments, 3:1 to 4:1. In some embodiments, the ratio of polymer of the topcoat layer 210 with reactive groups, such as a vinyl copolymer including vinyl alcohol, to crosslinker, such as polyisocyanate, by weight may be 5:1 to 15:1, in other embodiments, 7:1 to 12:1, and in yet other embodiments, 8:1 to 10:1. In one or more embodiments, the polymer or polymer blend may be about 30 to 95% by weight of the dry layer, in other embodiments, 40 to 90%, and in still other embodiments 55 to 65% by weight of the dry layer.

Referring again to FIGS. 2A-B, the base substrate 220 including base layers 240, 250 may include one or more thermoplastic polymers that melt upon heating for adhering and removing tape 200, 200′ to a fabric or textile substrate. In one or more embodiments, a base layer may have a Vicat softening temperature, per ASTM D1525, of about 80 to 120° C.; in other embodiments, the Vicat softening temperature may be about 90 to 110° C.; and in yet further embodiments, the Vicat softening temperature may be about 100° C. The one or more thermoplastic polymers of the base layers 240, 250 may have a flexural modulus, as determined by ASTM D790, of, in some embodiments, 3000 to 5000 psi, and in other embodiments, 3500 to 4500 psi. The tensile strength, as determined by ASTM D412, may be, in some embodiments, 4000 to 6000 psi, and in other embodiments, 4500 to 5500 psi. The elongation of the polymer of the base layer(s), as determined by ASTM D412, may be greater than 300%, in some embodiments, or greater than 500%, in other embodiments. The melt flow index (MFI), as determined by ASTM D1238, of the base layer(s) polymer(s) may be in certain embodiments, 1 to 100 g/10 min at 190° C. and 5 to 25 kg; and, in other embodiments, 1 to 60 g/10 min at 190° C. and 21.6 kg. The base layer may be supplied in any suitable form but is preferably a solid (e.g., powder, diced, pelletized). The base layer may further include an additive such as but not limited to a wax or flame retardant. In at least one embodiment, the additive may be present in an amount of 0.1 to 38% by weight of the base layer, in another embodiment, 0.1 to 10%, and in still another embodiment, 0.5 to 2%. In one or more embodiments, a base layer may include a thermoplastic polyurethane, and, in other embodiments, a thermoplastic polyether-based polyurethane may be used.

In one or more embodiments, the one or more thermoplastic polymers may form an adhesive bond with a fabric substrate. For example, the one or more thermoplastic polymers may form an adhesive bond to a cotton and/or polyester fabric. A suitable polymer may be a polyester thermoplastic polyurethane (i.e., polyester TPU or thermoplastic polyester polyurethane). Improved adhesion to the substrate may be obtained when a polymer in the adjacent base layer is similar to the composition of the substrate. Using a polyester TPU provides good adhesion to various fabric/textile substrates such as polyesters and cotton. Good adhesion also contributes to longevity, wash resistance, and against peeling. In one or more embodiments, the tape 200, 200′ has a pull strength at least 30 lbs/in² as measured by a pull test (ASTM D1876) when adhered to a polyester and/or cotton fabric substrate, in another embodiment, at least 50 lbs/in², in still another embodiment, at least 100 lbs/in². In a variation, the pull strength is 100 to 150 lbs/in², in other variations, 110 to 130 lbs/in², and in still other variations, 115 to 120 lbs/in². A higher pull strength also requires high cohesive strength. For example, the thermo-printable tape 200, 200′ may include a first base layer 240, which is Elastollan® TPU 1185A supplied by BASF located in Wyandotte, MI and a second base layer 250, which is Zyblend™ 126K-FR supplied by APS Compounding located in Romulus, Mich.

The topcoat layer 210 may include a pigment providing sufficient opacity for contrast with a printable ink. For example, titanium dioxide (TiO₂) may be used to provide a background for printing. Suitable pigments include, but are not limited to, UP-96-038 from Stahl USA, Inc. located in Peabody, Mass., Natron™ ST 310 from Boston Industrial Solutions, Inc. located in Woburn, Mass., and/or Fabrifast® Screen DE2 HTL Screen Ink 86-OK from Perfectos Printing Inks Co. Ltd., located in Normanton Lane, Bottesford, Nottingham, NG130EL, England, UK. In one or more embodiments, the pigment may be about 5 to 80% by weight of the dry layer (e.g., topcoat or basecoat), in other embodiments, 10 to 50%, in still other embodiments, 20 to 40%, and in yet other embodiments, 15 to 30%.

According to one or more embodiments of the present disclosure, the composition of the bulk material for the topcoat layer 210 is provided (i.e., a topcoat composition). Bulk material for topcoat layer 210 may include the polymer or polymer blend, the crosslinker, and a solvent. Bulk material for topcoat layer 210 may further include the pigment or one or more of the other additives. The solvent may provide processing or application benefits such as application at room temperature and faster drying. Further, use of a solvent may contribute beneficial flow properties and a viscosity that facilitates achieving a smooth surface for printing. The solvent may be any solvent suitable for dissolving the polymer or polymer blend, such as, but not limited to one or more organic solvent (e.g., isopropyl alcohol (IPA), methyl ethyl ketone (MEK), toluene). The solvent may have a boiling point of, in some embodiments, 150° F. to 310° F., and in other embodiments, 170° F. to 240° F. In one or more embodiments, the polymer or polymer blend may be about 20 to 90% by weight of the bulk material, in other embodiments, about 30 to 80%, and in still other embodiments, about 40 to 70%. The solvent, in some embodiments, may be 5 to 90% by weight of the bulk layer, in other embodiments 9 to 30% and in still other embodiments, 50 to 70%. A solvent based material may also provide enhanced inter-coat adhesion. For example, a solvent based topcoat layer 210 may provide good inter-coat adhesion with a basecoat layer 230. Without being bound by theory, it is believed that a solvent may soften or etch the surface to which it is applied. For example, a solvent based topcoat layer 210 may soften the dry basecoat layer 230. A soft surface may facilitate better inter-coat entanglement of polymer chains resulting in a bond from physical entanglement. It is also believed that a solvent increases the surface area at the adhesive interface. The surface area at the adhesive interface may be increased by creating small hills and valleys that are not visible (i.e., etch the surface). A solvent based topcoat layer may also have a lower viscosity and greater mobility to more easily penetrate into the basecoat layer. If unbonded functional groups remain in the basecoat layer 230 the crosslinker of the topcoat layer 210 may react with the reactive groups of the basecoat layer forming chemical bonds between the topcoat layer 210 and basecoat layer 230.

It should be understood that the amount of solvent can be adjusted to obtain a viscosity that is suitable for the application process. The solvent may be added as need to obtain a suitable application viscosity, such as in some embodiments, 10 to 300 centistokes, in other embodiments, 30 to 150 centistokes, and in yet other embodiments, 40 to 100 centistokes. It should also be understood that solvent can be removed to increase the viscosity for storage (i.e., a high viscosity discourages settling or caking). In one or more embodiments, the solvent may be present in the bulk material at 4 to 60% by weight of the total bulk material, in another embodiment, 5 to 60% by weight, in still another embodiment, 15 to 45% by weight of the total bulk material.

The polymer or polymer blend may be supplied as a solution. The bulk polymer or polymer blend may include a polyether-based polyurethane at, in some embodiments, 1 to 80% by weight of the solids content of the polymer blend, in other embodiments, 10 to 60%, and in yet other embodiments, 20 to 40%. The bulk polymer or polymer blend may include a vinyl at, in some embodiments, 5 to 90% by weight of the solids content of the polymer blend, in other embodiments, 20 to 70%, and in still other embodiments, 40 to 60%. The polymer blend may further include an epoxy polymer at about 0.5 to 30% by weight of solids content of the polymer blend, in other embodiments 3 to 20%, and in yet other embodiments 10 to 15%. Similarly, the crosslinker may be added as a solution with a solids content, in some embodiments, of 20 to 95% by weight of the total weight of the solution, in other embodiments, 35 to 85%, and in still other embodiments, 45 to 75%. In one or more embodiments, the crosslinker solution may be 0.1 to 40% by weight of the wet topcoat layer 210, in other embodiments 1 to 25%, in yet other embodiments 3 to 20%, in still other embodiments 10 to 20% and in still further embodiments, 1 to 5%.

In one or more embodiments, one or more additives not including the pigment may be present at about 0.005 to 5% by weight of the total bulk material, in other embodiments, 0.01 to 3%, and in still other embodiments, 0.5 to 1.5%. Pigment may be added as a powder and dispersed in the bulk material. Additives, such as, but not limited to one or more dispersing agents, surfactants, and/or wetting agents, may be included in the bulk material to facilitate dispersing the pigment. The pigment may already be dispersed in a medium forming a pigment dispersion (e.g., a medium of organic solvent, water, and/or resin such as dimethyl carbonate (DMC) and/or an acrylic polymer) and may resemble a liquid or a paste. The pigment dispersion may include, in some embodiments, 40 to 99% pigment by weight, in other embodiments 50 to 95% by weight, in yet other embodiments, 60 to 90% by weight, and in other embodiments, 70 to 85% by weight. In embodiments including a pigment, the pigment dispersion may be present as 5 to 90% by weight of the bulk material, in other embodiments, 10 to 60%, in still other embodiments, 30 to 40%. The pigment dispersion, in some embodiments, may be about 5 to 65% by weight of the bulk basecoat layer 230, in other embodiments 10 to 50%, and in still other embodiments 15 to 35%.

With respect to the thermo-printable tape and the bulk materials provided herein, the adjacent layers may be similar, substantially similar, or the same. Similar may indicate, for example, that the topcoat layer 210 and basecoat layer 230 have polymers of similar chemical nature. For example, if the topcoat layer 210 has a vinyl with hydroxyl functionality and the basecoat layer 230 has a different vinyl with hydroxyl functionality the layers would be considered similar. Likewise, a vinyl in the topcoat layer 210 and a different vinyl in the basecoat layer 230 may be considered similar. The same indicates, for example, that the chemical composition that makes up the polymer/polymer blend and crosslinker in the topcoat layer 210 also makes up the polymer/polymer blend and crosslinker in the basecoat layer 230. Substantially similar indicates, for example, that the chemical composition that makes up a polymer or crosslinker in the topcoat layer 210 is also in the basecoat layer 230. For example, if the topcoat layer 210 uses Permuthane® EX-XR-96-901 and the basecoat layer 230 also uses Permuthane® EX-XR-96-901 they would be considered substantially similar. However, similar, substantially similar or the same does not indicate the chemicals that make up the polymer or polymer blend are necessarily provided in the same ratios. For example, the crosslinker may not be provided at the same ratio in both the topcoat layer 210 and the basecoat layer 230 but they may still be considered similar, substantially similar, or same. In another example, if the basecoat layer 230 has a polymer blend including a polyether-based polyurethane, a vinyl copolymer of vinyl chloride, vinyl acetate and vinyl alcohol, an epoxy polymer and a polyisocyanate crosslinker, and the topcoat layer 210 has a polymer blend including the polyether-based polyurethane, the vinyl copolymer of vinyl chloride, vinyl acetate, and vinyl alcohol, the epoxy polymer, and the polyisocyanate crosslinker, it would be considered the same. A topcoat layer 210 with the polyether-based polyurethane would be considered substantially similar. A topcoat layer 210 with another polyether-based polyurethane would be considered similar. Likewise, a topcoat layer 210 with a polymer blend including the vinyl copolymer of vinyl chloride, vinyl acetate and vinyl alcohol would be substantially similar. A topcoat layer 210 with another vinyl copolymer of vinyl chloride, vinyl acetate and vinyl alcohol would be considered similar. In at least one embodiment, the topcoat layer 210 may similar, substantially similar or the same as the basecoat layer 230. Likewise, the basecoat layer 230 may be similar, substantially similar or the same as the adjacent base layer. Finally, the base layers may be similar, substantially similar or the same. For example, the topcoat layer 210 and basecoat layer 230 may be substantially similar. the basecoat layer and the adjacent base layer may be similar, and the base layers may be similar. The same, substantially similar, or similar polymers in adjacent layers may achieve strong inter-coat adhesion. Greater inter-coat adhesion will be achieved with adjacent layers that are similar. For example, a polyether-based polyurethane topcoat adjacent to a polyether-based polyurethane basecoat, which is adjacent to a polyether-based polyurethane base layer that is adjacent to a polyester polyurethane base layer will provide great inter-coat adhesion.

The same, substantially similar, and similar layers will also provide good wetting. Good wetting contributes to inter-coat adhesion, and uniformity. Wetting may be determined by measuring the contact angle. In one or more embodiments, good wetting may indicate a contact angle of at most 90°, in other embodiments, at most 75°, in yet other embodiments, at most 45°, and in still other embodiments, at most 25°. For example, the contact angle between a wet topcoat layer 210 and a dry basecoat layer 230 may at most 45°. In one or more embodiments, wettability and/or solvent softening may facilitate application of the topcoat layer 210 to the basecoat layer 230. For example, the wet topcoat layer may not flow off or bleed off of the dry basecoat layer. In one or more embodiments, this may provide better inter-coat adhesion and better appearance.

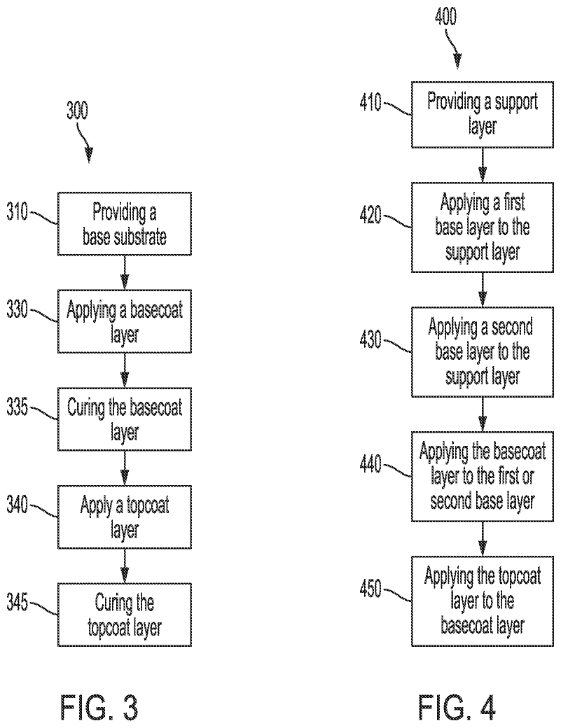

FIGS. 3 and 4 illustrate methods of making thermo-printable tapes. In method 300, step 310 includes providing a base substrate. Generally, providing or applying indicates an application by any suitable means such as but not limited to spraying, extruding, gravure coating, or reverse roll coating. In one variation, the base substrate may be extruded at about 160 to 240° C., or in other embodiments, 175 to 225° C., in still other embodiments, 100 to 160° C., and in yet other embodiments, 110 to 140° C. In a refinement, the base substrate may be provided at about 25 to 250 g/m², in another refinement, about 50 to 225 g/m², and in still another refinement, about 120 to 180 g/m². In at least one variation, the base substrate may be formed by extruding first and second base layers as described herein. In one or more embodiments, a first base layer may be extruded at about 25 to 200 g/m², in another embodiment, 75 to 140 g/m², and in still another embodiment, 100 to 130 g/m². Similarly, in some embodiments, the second base layer may be applied at about 50 to 250 g/m², in other embodiments, 75 to 225 g/m², and in yet other embodiments, 120 to 180 g/m².

Step 330 includes applying a wet basecoat layer, as described herein, to the base substrate. In a refinement, where two or more base layers form the base substrate, the basecoat layer is applied to the most similar exterior base layer. For example, when the base substrate is formed from a polyether-based polyurethane base layer and a polyester polyurethane base layer, a polyether-based polyurethane basecoat may be applied to the polyether-based polyurethane base layer for superior inter-coat adhesion and strength. The basecoat layer may be mixed before it is applied to the base substrate. In one or more embodiments, the crosslinker may be added and mixed to achieve a homogenous mixture shortly before applying. For example, the crosslinker may be added and mixed for at least 5 minutes in one embodiment, at least 3 minutes, in another embodiment, and at least 30 seconds, in still another embodiment. Mechanical mixing may be used, for example, by a propeller blade. The basecoat layer may be applied by gravure coating or reverse-roll coating. Reverse-roll coating may provide better control, appearance and uniformity of the coating during the application process. In at least one embodiment, the basecoat layer may be applied at about 1 to 40 g/m², in other embodiments, 1 to 30 g/m², and in still other embodiments, 3 to 20 g/m². In at least one embodiment, the basecoat layer may be cured, in any suitable manner, such as, but not limited to drying and/or heating (i.e., step 335).

Step 340 includes applying a topcoat layer, as described herein, to the basecoat layer forming a thermo-printable tape. The topcoat layer may be applied in the same or similar manner to the basecoat layer. In some embodiments, the topcoat layer may be applied at 1 to 40 g/m², in other embodiments, 2 to 30 g/m², and in yet other embodiments, 3 to 20 g/m². In one or more embodiments, the topcoat layer may be applied within 10 minutes of curing the basecoat layer, in other embodiments, within 1 hour, in still other embodiments, within 2 to 4 hours, in another variation, within 24 hours, and in still another variation, within 72 hours. The use of a solvent-based topcoat layer and/or solvent based basecoat layer also allows for application methods that can provide a smoother surface as compared with more conventional thermoplastic tapes that are heated and extruded. Further, solvent based layers may allow for applications that provide greater uniformity. Generally, the bulk material may be applied as is or as the wet coating layer, however, the bulk material can be diluted with solvent to obtain a viscosity for specific application methods and film thicknesses. Finally, the topcoat layer can be cured in a similar or the same manner as the basecoat layer and as described above (i.e., step 345).

FIG. 4 illustrates another method of making a thermo-printable tape 400. Step 410 includes providing a support layer with a first side and second side opposite the first side. Step 420 includes applying a first base layer to the first side of the support layer. Step 430 includes applying a second base layer to the second side of the support layer to form a base substrate. The base layers may be heated until flowable and/or extruded onto the support layer in at least one embodiment. In at least one variation, the base layer may be heated to no less than 180° F., in another variation, no less than 300° F., in still another variation, from 300 to 375° F., and in yet another variation, from 330 to 350° F. The base substrate may be passed through a roller or a series of rollers, directly or in an s-pattern, with one or more of the rollers applying pressure or the layers passing through a nip at any point while forming the base substrate. For example, a first base layer applied to the support layer may be rolled such that the first base layer penetrates into the open structure of the support layer. In a refinement, the base layers may be cured or solidified by cooling at ambient conditions or by active cooling such as by running cooling water through the rollers. One or more rollers may be cooled to facilitate cooling the base layers. For example, the roller may have cooling water passing through it. Rollers may likewise be used in method 300 to ensure interfacial contact and good inter-coat adhesion between the base layers.

In still another variation, the base substrate is passed through one or more rollers after the first and second base layers are applied to the support layer. Preferably, the first and second base layers come into contact or adheres together by penetrating into or through the support layer if a support layer is used. In one or more embodiments, the first base layer and second base layer may form a bond. It should also be understood that no specific order or sequence is required for forming the base substrate. Step 440 includes applying a basecoat layer to the base substrate as described above with regards to method 300. Step 450 includes applying a topcoat layer to the basecoat layer as described above with regards to method 300.

The topcoat and basecoat layers may be prepared by adding a portion of or all of the solvent into a vessel. Then, while mechanically mixing, the polymer or polymer blend may be added and dissolved. For example, in one embodiment, the polymer and solvent are mixed for 5 to 30 minutes or until the polymer blend is dissolved, dispersed, or emulsified. Additives that facilitate dispersing the pigment may be added while mixing. The pigment may then be added and mixed for an additional 5 to 30 minutes or until an appropriate dispersion is achieved. In one or more embodiments, the remaining portion of the solvent may be added. In one or more embodiments, the temperature may be monitored and/or the mixing vessel may be cooled. Unless using a blocked crosslinker, the crosslinker will be stored separately until the topcoat/basecoat layer is ready to be applied. The crosslinker should be mechanically mixed in shortly before applying. Mechanical mixing such as with a high dispersion blade or flow blade. Mechanical mixing may also be performed with a pin mixer. It should be understood that various sequences and equipment for preparation of the topcoat and basecoat may be used and are known by one skilled in the art.

A thermo-printable tape formed by the components and methods described herein provide not only a smooth surface, but also a uniform surface for improvements in print quality. Uniform may be used to refer to any measurable property, such as smoothness (i.e., surface roughness) or thickness. In one or more embodiments, uniform may indicate that a series of measurements does not exceed ±25% from an average of the series of measurements, in other embodiments, ±10%, and in still other embodiments, ±5%. In a variation, the series of measurements may include 10 measurements, in another variation, 5 measurements, and in still another variation, 3 measurements. In a refinement, the series of measurements may be randomly located, in another refinement, each measurement in the series of measurements may be qualified to a specific portion or region. For example, 3 measurements with one measurement on the left, one measurement in the center and one measurement one the right may be used. Unless specified otherwise uniform indicates a difference of not more than ±10% determined by taking 3 measurements, wherein one measurement is on the left portion of a sample, one measurement is on the central portion of the sample, and one measurement is on the right portion of the sample.

According to one or more embodiments, a thermo-printable tape includes an at least partially crosslinked basecoat and a topcoat layer to improve the structural integrity of labels formed from the tape over the lifetime of label. The basecoat and/or topcoat layers include a polymer blend of a polyether-based polyurethane, a vinyl, an epoxy polymer or a combination thereof, which is at least partially crosslinked by a polyisocyanate crosslinker, such that a strong bonded polymer network with good inter-coat adhesion and strength having enhanced wash resistance, stain resistance, and resistance to discoloration is produced. The coatings may be applied to an extruded base substrate by wet application via gravure or reverse roll coating to form a thermo-printable tape with a smooth surface and superior wash resistance.

While exemplary embodiments are described above, it is not intended that these embodiments describe all possible forms encompassed by the claims. The words used in the specification are words of description rather than limitation, and it is understood that various changes can be made without departing from the scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A thermo-printable tape comprising:
a base substrate having a first side for attaching to a fabric substrate and a second side opposite the first side, the base substrate including a thermoplastic polyurethane;
a basecoat layer disposed on the second side of the base substrate, the basecoat layer including an at least partially crosslinked polyurethane; and
a topcoat layer being disposed on the basecoat layer, the topcoat layer having a polymer network with polyurethane crosslinks formed from at least two of a polyurethane, a vinyl and an epoxy polymer, the topcoat layer having a smooth printable surface with a roughness of at most 50 μin without calendaring as measured by a profilometer per ASME B46.1.

2. The thermo-printable tape of claim 1, wherein the base substrate includes a first base layer including a thermoplastic polyester polyurethane forming the first side and a second base layer including a thermoplastic polyether-based polyurethane forming the second side.

3. The thermo-printable tape of claim 2, wherein the base substrate includes a support layer between the first base layer and the second base layer.

4. The thermo-printable tape of claim 2, wherein the topcoat layer has a first thickness of about 2 to 130 μm, the basecoat layer has a second thickness of about 2 to 130 μm, the first base layer has a third thickness of about 25 to 255 μm and the second base layer has a fourth thickness of about 25 to 255 μm.

5. The thermo-printable tape of claim 1, wherein at least one of the topcoat layer and the basecoat layer include a pigment.

6. The thermo-printable tape of claim 1, wherein the polyurethane of the topcoat layer is present and is a thermoplastic polyether-based polyurethane.

7. The thermo-printable tape of claim 6, wherein the vinyl is present and is a vinyl copolymer.

8. The thermo-printable tape of claim 7, wherein the vinyl copolymer includes a vinyl alcohol and at least one of a vinyl chloride and a vinyl acetate.

9. The thermo-printable tape of claim 1, wherein the vinyl is present and has a hydroxyl content of less than 10% by weight of the vinyl.

10. The thermo-printable tape of claim 1, wherein the thermo-printable tape has a pull strength of at least 100 lbs/in² when adhered to the fabric substrate as measured by ASTM D1876.

11. The thermo-printable tape of claim 1, wherein the smooth printable surface has a roughness of at most 25 μin without calendaring as measured by a profilometer per ASME B46.1.

12. The thermo-printable tape of claim 1, wherein the smooth printable surface has a roughness of about 10 to 25 μin without calendaring as measured by a profilometer per ASME B46.1.

13. The thermo-printable tape of claim 1, wherein the topcoat layer and basecoat layer are at least partially crosslinked together and/or physically entangled promoting inter-coat adhesion.

14. The thermo-printable tape of claim 1, wherein the smooth printable surface of the topcoat layer is uniform such that at least 3 different measurements of surface roughness (Rₐ) as measured by a profilometer per ASME B46.1 at 3 different locations on the smooth printable surface have an average and each of the at least 3 different measurement is within ±25% of the average.

15. The thermo-printable tape of claim 1, wherein the polymer network with polyurethane crosslinks is formed from the polyurethane, the vinyl and the epoxy polymer.

16. The thermo-printable tape of claim 1, wherein 0.001 to 10% by weight of the of the polymer network is free reactive groups.

17. A topcoat composition for a thermo-printable tape comprising:
about 20 to 90% by weight of a polymer blend, the polymer blend including at least two of a polyether-based polyurethane, a vinyl, and an epoxy polymer;
about 1 to 25% by weight of a polyisocyanate crosslinker;
about 5 to 60% by weight of titanium dioxide; and
solvent;
wherein upon curing, the topcoat composition forms an at least partially crosslinked coating having a smooth printable surface with a roughness of at most 50 μin without calendaring as measured with a profilometer per ASME B46.1.

18. The topcoat composition of claim 17, wherein the vinyl is a vinyl copolymer including a vinyl alcohol and at least one of vinyl chloride and vinyl acetate, the vinyl having a hydroxyl content of less than 10% by weight.

19. The topcoat composition of claim 17, wherein the polymer blend is about 50 to 70% by weight of the topcoat composition.

20. The topcoat composition of claim 17, wherein the polyisocyanate crosslinker has free reactive groups comprising about 5 to 30% by weight of the polyisocyanate crosslinker.

21. The topcoat composition of claim 17, wherein polymer blend includes the polyether-based polyurethane at about 10 to 60% by weight of a solids content of the polymer blend, the vinyl at about 20 to 70% by weight of the solids content of the polymer blend, and the epoxy polymer at about 3 to 20% by weight of the solids content of the polymer blend.

22. A method for forming a thermo-printable tape comprising:
providing a base substrate having a first side for bonding to a fabric substrate and a second side opposite the first side;
applying a wet basecoat layer including a first polyisocyanate crosslinker to the base substrate;
curing the wet basecoat layer to form a dry basecoat layer bonded to the base substrate;
applying a wet topcoat layer to the dry basecoat layer, the wet topcoat layer including a second polyisocyanate crosslinker and polymer blend having at least two of a polyether-based polyurethane, a vinyl having a hydroxyl content of less than 10% by weight of the vinyl, an epoxy polymer; and
curing the wet topcoat layer to form a dry topcoat layer bonded to the dry basecoat layer wherein the polymer blend and second polyisocyanate crosslinker form an at least partially crosslinked polymer network.

23. The method of claim 22, wherein providing the base substrate includes extruding a thermoplastic polyester polyurethane to form the first side and extruding a thermoplastic polyether-based polyurethane to form the second side, wherein the thermoplastic polyester polyurethane and the thermoplastic polyether-based polyurethane are bonded together.

24. The method of claim 23, wherein the base substrate includes a support layer between the thermoplastic polyester polyurethane and the thermoplastic polyether-based polyurethane such that the thermoplastic polyester polyurethane and the polyether-based polyurethane are bonded within an open structure of the support layer.

25. The method of claim 22, wherein applying the wet topcoat layer includes spraying, extruding, gravure coating, or reverse roll coating.

26. The method of claim 25, wherein applying the wet topcoat layer includes reverse roll coating.

27. The method of claim 22, wherein the wet topcoat layer is applied at 10 to 15 g/m².

28. The method of claim 22, wherein the wet topcoat layer has a contact angle of at most 45° with the dry basecoat layer.

29. A topcoat composition for a thermo-printable tape comprising:
about 20 to 90% by weight of a polymer blend, the polymer blend including at least two of polyether-based polyurethane, a vinyl, and an epoxy polymer;
about 5 to 60% by weight of titanium dioxide; and
about 5 to 60% by weight of a solvent;
wherein the topcoat composition when mixed and cured with a polyisocyanate crosslinker forms a dry topcoat layer having an at least partially crosslinked polymer network.
